(19) United States
(12) Patent Application Publication
(10) Pub. No.: US 2025/0046901 A1
(43) Pub. Date: Feb. 6, 2025

(54) PROCESSING METHOD FOR BATTERY MEMBER

(71) Applicant: Prime Planet Energy & Solutions, Inc., Tokyo (JP)

(72) Inventors: Shinya SUZUKI, Kobe-shi (JP); Yutaka OYAMA, Toyota-shi (JP); Koji OKUDA, Nagoya-shi (JP); Yusuke HINO, Tokyo (JP)

(21) Appl. No.: 18/789,685

(22) Filed: Jul. 31, 2024

(30) Foreign Application Priority Data
Aug. 3, 2023 (JP) 2023-126811

(51) Int. Cl. H01M 10/54; C22B 1/24; C22B 3/00; C22B 3/22; C22B 7/00; C22B 23/02

(52) U.S. Cl. CPC H01M 10/54; C22B 1/2406; C22B 3/22; C22B 7/001; C22B 7/007; C22B 23/02; C22B 23/043; C22B 23/0453

(57) ABSTRACT

A processing method disclosed herein includes a heating step of heating at 850° C. or more, a collection target including a positive electrode containing at least a lithium-transition metal complex oxide with a layer structure and a negative electrode containing a carbon material, and a separating step of adding a foaming agent and a scavenger to a slurry including the collection target after the heating step and separating a metal component and a carbon component included in the collection target.

### CROSS REFERENCE TO RELATED APPLICATION

This application claims the benefit of priority to Japanese Patent Application No. 2023-126811 filed on Aug. 3, 2023. The entire contents of this application are hereby incorporated herein by reference.

### BACKGROUND OF THE DISCLOSURE

### 1. Field

The art disclosed herein relates to a processing method for a battery member.

### 2. Background

Lithium ion secondary batteries have been used widely in various fields. Various materials including a metal component such as Ni, Co, or Mn and a carbon material such as graphite are used in this lithium ion secondary battery. For a positive electrode active material, for example, a lithium-transition metal complex oxide such as a lithium-nickel complex oxide, a lithium-cobalt complex oxide, or a lithium-nickel-cobalt-manganese complex oxide is used. For a positive electrode core body, an aluminum foil or the like is used. On the other hand, a carbon material or the like is used for a negative electrode active material. For a negative electrode core body, a copper foil or the like is used.

In recent years, a collection technique for collecting metal components and carbon components from used batteries, process mill ends, or the like, and reusing such components as battery materials has been examined. For example, “Ruiting Zhan, Zachary Oldenburg, Lei Pan, Recovery of active cathode materials from lithium-ion batteries using froth flotation, Sustainable Materials and Technologies 17, September 2018” discloses that after a slurry including a collection target is filtered and sintered at 500° C., flotation mineral beneficiation is performed to separate a positive electrode active material and graphite.

### SUMMARY

According to “Ruiting Zhan, Zachary Oldenburg, Lei Pan, Recovery of active cathode materials from lithium-ion batteries using froth flotation, Sustainable Materials and Technologies 17, September 2018”, a loss rate of the positive electrode active material is 8% when a graphite collection rate is 98% or more. In recent years, for example, there has been a movement of seeking a high resource cycling rate (95% or more) in Europe and it has been demanded to achieve both a higher collection rate of the carbon component and a lower loss rate of the metal component in the positive electrode active material. In particular, the loss rate of the metal component is preferably 5% or less.

The present disclosure has been made in view of such circumstances, and a main object is to provide a processing method for a battery member, that achieves both a higher collection rate of a carbon component and a lower loss rate of a metal component.

A processing method for a battery member disclosed herein includes a heating step of heating at 850° C. or more, a collection target including a positive electrode containing at least a lithium-transition metal complex oxide with a layer structure and a negative electrode containing a carbon material, and a separating step of adding a foaming agent and a scavenger to a slurry including the collection target after the heating step and separating a metal component and a carbon component included in the collection target.

In the processing method with the above structure, by heating the collection target at 850° C. or more, the metal component in the collection target is reduced to a state of a metal simple substance. Additionally, the metal simple substance is aggregated, so that the specific gravity can be increased suitably. Thus, the precipitability of the metal component is improved and the separativeness from the carbon component is improved. Therefore, the metal component and the carbon component can be separated suitably in the separating step and both a higher collection rate of the carbon component and a lower loss rate of the metal component can be achieved.

### BRIEF DESCRIPTION OF THE DRAWINGS

FIG. 1 is a longitudinal cross-sectional view schematically illustrating an internal structure of a lithium ion secondary battery;

FIG. 2 is a perspective view schematically illustrating an electrode body of the lithium ion secondary battery illustrated in FIG. 1;

FIG. 3 is a flowchart for describing a processing method for a battery member according to one embodiment; and

FIG. 4 is a flowchart for describing a heating step in a processing method according to one embodiment in detail.

### DETAILED DESCRIPTION OF THE PREFERRED EMBODIMENTS

Embodiments of the art disclosed herein will hereinafter be described with reference to the drawings. Matters that are other than the matters particularly mentioned in the present specification and that are necessary for the implementation of the art disclosed herein can be grasped as design matters of those skilled in the art based on the prior art in the relevant field. The art disclosed herein can be implemented on the basis of the contents disclosed in the present specification and common technical knowledge in the relevant field.

### 1. Collection Target

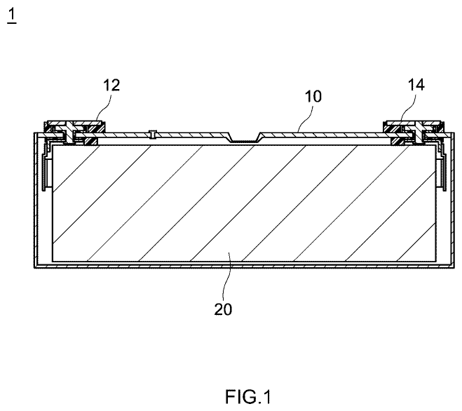

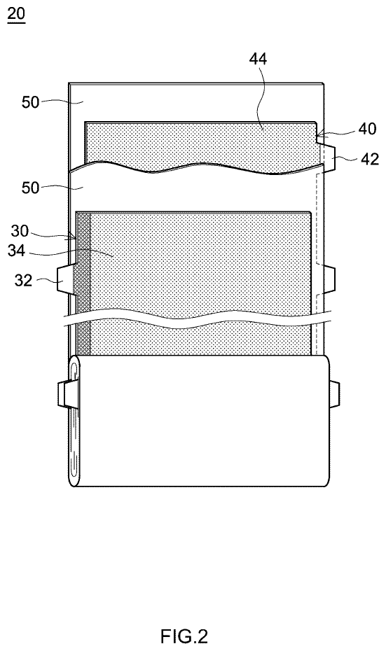

A processing method for a battery member disclosed herein is a method of separating a metal component such as Ni, Co, or Mn and a carbon component such as graphite from a predetermined collection target and collecting such components. The collected metal component and carbon component can be suitably used as a material of a positive electrode active material and/or a material of a negative electrode active material of a lithium ion secondary battery, for example. One example of the collection target here is a used lithium ion secondary battery. This lithium ion secondary battery is specifically described below. FIG. 1 is a longitudinal cross-sectional view schematically illustrating an internal structure of the lithium ion secondary battery. FIG. 2 is a perspective view schematically illustrating an electrode body of the lithium ion secondary battery illustrated in FIG. 1.

As illustrated in FIG. 1, a lithium ion secondary battery 1 includes a case 10, an electrode body 20, and an electrolyte (not illustrated).

### (1) Case

The case 10 is a box-shaped container. This case 10 internally accommodates the electrode body 20 and the electrolyte. The case 10 is formed of, for example, a metal material with a certain strength (such as aluminum (Al)). In addition, a positive electrode terminal 12 and a negative electrode terminal 14 are attached to the case 10. The positive electrode terminal 12 and the negative electrode terminal 14 are connected to the electrode body 20 inside the case 10. Specifically, the positive electrode terminal 12 is connected to a positive electrode plate 30 (see FIG. 2) of the electrode body 20. This positive electrode terminal 12 is formed of aluminum (Al) or the like. On the other hand, the negative electrode terminal 14 is connected to a negative electrode plate 40 (see FIG. 2) of the electrode body 20. This negative electrode terminal 14 is formed of copper (Cu) or the like.

### (2) Electrode Body

The electrode body 20 is an electrical energy generation element of the lithium ion secondary battery 1. As illustrated in FIG. 2, the electrode body 20 includes the positive electrode plate 30, the negative electrode plate 40, and a separator 50. Note that the electrode body 20 illustrated in FIG. 2 is a wound electrode body here. This wound electrode body is manufactured by forming a long multilayer body with a band shape in which the positive electrode plate 30, the negative electrode plate 40, and the separator 50 are stacked, and winding the multilayer body. However, the structure of the electrode body 20 is not limited in particular and may be another conventionally known structure (such as a multilayer type electrode body).

The positive electrode plate 30 includes a positive electrode core body 32, which is a metal foil with electrical conductivity, and a positive electrode active material layer 34 provided on a surface of the positive electrode core body 32. The positive electrode core body 32 is formed of a metal foil (for example, aluminum foil). The positive electrode active material layer 34 is a mixture layer including the positive electrode active material, a conductive material, a binder, and the like. The positive electrode active material is preferably a lithium-transition metal complex oxide with a layer structure. Examples of such a lithium-transition metal complex oxide with the layer structure include a lithium-nickel complex oxide, a lithium-cobalt complex oxide, a lithium-nickel-manganese-cobalt complex oxide, and the like. By the processing method according to this embodiment, the metal component (valuable metal) such as Ni, Co, or Mn can be collected efficiently from a collection target containing such a lithium-transition metal complex oxide with the layer structure. Examples of the conductive material included in the positive electrode active material layer 34 include carbon materials such as acetylene black and graphite. Examples of the binder included in the positive electrode active material layer 34 include a resin material such as polyvinylidene fluoride (PVdF).

The negative electrode plate 40 includes a negative electrode core body 42, which is a metal foil with electrical conductivity, and a negative electrode active material layer 44 provided on a surface of the negative electrode core body 42. The negative electrode core body 42 is formed of a metal foil (for example, copper foil). The negative electrode active material layer 44 is a mixture layer including the negative electrode active material, a binder, a thickener, and the like. The negative electrode active material includes a carbon material. Examples of the carbon material include graphite, hard carbon, soft carbon, and the like. Additionally, the negative electrode active material may include silicon (Si), a complex containing carbon and silicon (SiC), silicon oxide (SiOₓ), or the like. In particular, the negative electrode active material preferably includes graphite. Examples of the binder included in the negative electrode active material layer include a resin material such as styrene butadiene rubber (SBR). Examples of the thickener included in the negative electrode active material layer include a resin material such as carboxymethyl cellulose.

The separator 50 is an insulating sheet held between the positive electrode plate 30 and the negative electrode plate 40. For this separator 50, for example, a resin material such as polyethylene (PE), polypropylene (PP), polyester, cellulose, or polyamide is used. On a surface of the separator 50, a heat-resistant layer including inorganic filler may be formed. Examples of the inorganic filler include inorganic oxides such as aluminum oxide, magnesium oxide, silicon oxide, and titanium oxide, nitrides such as aluminum nitride and silicon nitride, metal hydroxides such as calcium hydroxide, magnesium hydroxide, and aluminum hydroxide, clay minerals such as mica, talc, boehmite, zeolite, apatite, and kaolin, and the like.

### (3) Electrolyte

The electrolyte exists between the positive electrode plate 30 and the negative electrode plate 40. Thus, charge carriers (Li ions) can be transferred between the positive electrode plate 30 and the negative electrode plate 40. Examples of the electrolyte include a nonaqueous electrolyte solution, a gel electrolyte, and the like. Note that electrolytes that can be used for the lithium ion secondary battery can be used as the electrolyte without particular limitations, and the art disclosed herein is not limited thereby.

Thus, the lithium ion secondary battery 1 has been described above as one example of the collection target in the processing method according to this embodiment. The processing method disclosed herein, however, is not limited only to the method in which the lithium ion secondary battery 1 with the aforementioned structure is the collection target. In another example, in a manufacturing site for the lithium ion secondary battery, the product may become unusable due to some defect occurring in the manufactured electrode body. Such an electrode body can also be the collection target because of containing the metal component (valuable metal) derived from the positive electrode active material, such as Ni or Co, or the carbon material derived from the negative electrode active material, such as graphite. Furthermore, the electrode body extracted by decomposing the used secondary battery can also be the collection target because of containing the metal component derived from the positive electrode active material, such as Ni or Co, or the carbon material derived from the negative electrode active material, such as graphite. That is to say, the collection target in the processing method disclosed herein only needs to contain at least the lithium-transition metal complex oxide with the layer structure and the carbon material, and is not limited particularly to a specific structure.

### 2. Processing Method for Battery Member

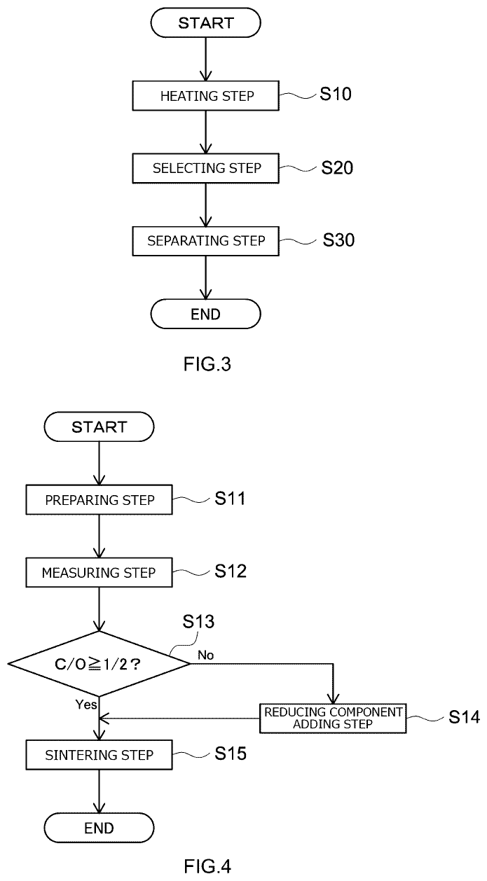

The processing method for the battery member disclosed herein will be described below. FIG. 3 is a flowchart for describing the processing method disclosed herein. FIG. 4 is a flowchart for describing a heating step in FIG. 3 in detail. The processing method for the battery member disclosed herein includes at least a heating step S10 and a separating step S30. In the separating step S30, the metal component and the carbon component are physically selected and collected using the hydrophilicity of the metal component and the hydrophobicity of the carbon component, which will be described in detail below. The processing method disclosed herein may further include a selecting step S20. By the processing method disclosed herein, the precipitability of the metal component is improved, so that the separativeness of the metal component and the carbon component is improved in the separating step S30. Accordingly, both the higher collection rate of the carbon component and the lower loss rate of the metal component can be achieved suitably.

In this specification, the term “the collection rate of the carbon material” refers to the amount of carbon collected in the separating step relative to the amount of carbon in the collection target supplied to the separating step. The amount of carbon can be calculated by, for example, thermogravimetry-differential thermal analysis (TG-DTA). The term “the loss rate of the metal component” refers to the value obtained in such a way that the amount of metal collected in the separating step relative to the amount of metal in the collection target supplied to the separating step is obtained and then this value is subtracted from 100%. The amount of metal can be calculated by, for example, inductively coupled plasma (ICP) analysis.

### (1) Heating Step S10

In the heating step S10, the collection target described above is heated at 850° C. or more. In the collection target, the metal component (for example, Ni, Co, or Mn) included in the positive electrode active material exists as a metal ion. By heating the collection target at 850° C. or more in the heating step S10, the metal component can be reduced suitably to a state of a metal simple substance (metal Ni, metal Co, or metal Mn). Moreover, by heating at 850° C. or more at minimum, the reduced metal simple substance can be aggregated and the specific gravity of the metal component can be increased; thus, the precipitability is improved. Thus, in the separating step S30 to be described below, the separativeness of the metal component and the carbon component can be suitably improved.

In the heating step S10, by heating the collection target described above, a liquid component (for example, electrolyte solution) in the collection target and a film on a surface of the positive electrode active material can be removed suitably. Additionally, a resin component (binder, separator, or the like) included in the collection target can be carbonized. In the case where the charged lithium ion secondary battery 1 is the collection target, the function as a battery can be stopped by performing the heating step S10. Thus, the subsequent steps can be carried out safely. Although there is no particular limitation, the heating step S10 may include a preparing step S11, a measuring step S12, a determining step S13, a reducing component adding step S14, and a sintering step S15 as illustrated in FIG. 4. Specific description will be made below.

### (a) Preparing Step S11

In the preparing step S11, the collection target including a positive electrode containing at least the lithium-transition metal complex oxide with the layer structure and a negative electrode containing the carbon material is prepared. That is to say, the collection target in the art disclosed herein is not limited to the completed lithium ion secondary battery and encompasses defective components (electrode body, for example), the electrode body after the battery is disassembled, and the like. Note that since the details of the collection target are already described, the overlapping description is omitted.

### (b) Measuring Step S12

In the measuring step S12, the amount of substance of each of the reducing component and an oxygen element (O) in the collection target is measured. In the measuring step S12, a part of the collection target may be extracted as a measurement sample and the oxygen element and the reducing component in the measurement sample may be measured. Moreover, the measuring step S12 may be performed only in a case where the kind of collection target is changed and does not have to be performed on all the prepared collection targets. In this manner, the processing efficiency can be improved.

Note that the term “reducing component” in this specification is not limited in particular as long as the reducing component can reduce the metal component included in the positive electrode active material (for example, Ni, Co, Mn, or the like) in the sintering step S15 to be described below. In the processing method disclosed herein, a carbon element (C) can be preferably employed as the reducing component. Carbon can be employed as the reducing component particularly preferably from the viewpoint of being resistant against oxidation and stable until the sintering step S15 is started. The kind of collection target can include various carbon materials (conductive material, binder, negative electrode active material, and the like). By using these carbon materials as a supply source for the reducing component, the cost required for the collection can be reduced.

A means that measures the amount of substance of the reducing component (carbon element) in the collection target is not limited in particular and a conventionally known measuring means can be used without particular limitations. Examples of the means that measures the amount of substance of the carbon element include thermogravimetry-differential thermal analysis (TG-DTA), SEM-EDS analysis, an oxygen stream combustion-non-dispersive infrared analysis method, a combustion gasometric method, and the like.

Next, a means that measures the amount of substance of the oxygen element in the collection target is described. First, in a case where the chemical composition of the positive electrode active material in the collection target is already grasped, the amount of substance of the metal element in the collection target is preferably measured and based on the amount of substance of the metal element, the amount of substance of the oxygen element is preferably calculated. Thus, the amount of substance of the oxygen element in metal oxide (for example, lithium-transition metal complex oxide with the layer structure) can be measured easily. A specific example of such a measurement procedure is as follows. First, a solution in which a part of the collection target (measurement sample) is dissolved in acid is prepared. Next, this solution is subjected to inductively coupled plasma (ICP) analysis. Thus, the total amount of substance of the transition metal elements (Ni, Co, and Mn), which is M, in the collection target can be measured. If the chemical composition (LiNiₓCo_{y}Mn_{z}O_{δ}) of the positive electrode active material in the collection target is already grasped, the ratio (x+y+z:δ) between the total amount of substance of the transition metal elements (x+y+z) and the amount of substance of O(δ) can be obtained. In this case, the amount of substance of the oxygen element, which is N, can be calculated from the measurement result of ICP (total amount of substance of the metal elements, M) in accordance with the following Formula (1):

$$N = δ \cdot M / ( x + y + z ) \qquad ( 1 )$$

Note that the means that measures the amount of substance of the oxygen element in the collection target is not limited to the aforementioned means and a conventionally known measuring means can be used without particular limitations. For example, the oxygen element in the collection target may be measured directly using the SEM-EDS analysis, XRF analysis, or the like. By using these methods, the amount of substance of the oxygen element can be measured even when the chemical composition of the positive electrode active material in the collection target is unknown.

### (c) Determining Step S13

In the determining step S13, it is determined whether the ratio of the amount of substance of the reducing component to that of the oxygen element is more than or equal to a predetermined threshold. Here, the threshold in this step is set based on the stoichiometric ratio of an oxide of the reducing component. For example, in the case of using the carbon element as the reducing component, the oxide of the reducing component is carbon dioxide (CO₂). At this time, in the sintering step S15 to be described below, it is preferable that the threshold be more than or equal to the ratio (1/2) of the carbon element to the oxygen element in CO₂ in order to reduce suitably the metal component included in the positive electrode active material. In the determining step S13, it is determined whether the ratio (also referred to as “C/O ratio” below) of the amount of substance of the carbon element (reducing component) to that of the oxygen element in the collection target is 1/2 or more. If the C/O ratio is 1/2 or more (YES in S13 in FIG. 4), the process advances to the sintering step S15. On the other hand, if the C/O ratio is less than 1/2 (NO in S13 in FIG. 4), the process preferably advances to the reducing component adding step S14. Thus, the metal component can be reduced to the state of the metal simple substance more suitably.

Note that, as described above, the threshold in this step may be set at a value more than or equal to the stoichiometric ratio of the oxide of the reducing component. For example, in the case where the reducing component is the carbon element, the threshold may be set to 3/4 or more (more preferably 1 or more, still more preferably 5/4 or more, and particularly preferably 3/2 or more). Thus, only the collection target containing the reducing component (carbon element) in a large quantity can be supplied to the sintering step S15, and accordingly, the reduction of the metal oxide in the sintering step S15 can be promoted further.

### (d) Reducing Component Adding Step S14

The reducing component adding step S14 is a step of adding the reducing component to the collection target if the determination result in the determining step S13 is less than the threshold (NO in S13 in FIG. 4). In the processing method disclosed herein, the reducing component adding step S14 is preferably performed in the case where the determination result in the determining step S13 is less than the threshold. For example, it is preferable to add the reducing component (carbon-containing material) to the collection target whose C/O ratio has been determined to be less than 1/2 in the determining step S13 so that this C/O ratio becomes more than or equal to the threshold (1/2 or more). Thus, the metal component included in the positive electrode active material can be reduced more suitably to the state of the metal simple substance. Here, as the carbon-containing material, a carbon material such as graphite, hard carbon, or soft carbon is given. For example, the negative electrode plate 40 containing the carbon material such as graphite may be added further. The carbon-containing material may alternatively be a resin material such as polyolefin or polyester. These resin materials generate the carbon element by carbonization in the initial stage of the sintering step S15 and accordingly are usable as a supply source for the carbon element.

In the reducing component adding step S14, the reducing component may be added in a quantity far more than the threshold described above. For example, in the case where the reducing component is the carbon element, the carbon-containing material may be added so that the C/O ratio in the collection target becomes 3/4 or more (more preferably 1 or more, still more preferably 5/4 or more, and particularly preferably 3/2 or more). Thus, the collection target containing the reducing component (carbon element) in a large quantity can be supplied to the sintering step S15; therefore, the reduction of the metal oxide in the sintering step S15 can be promoted further.

### (e) Sintering Step S15

In the sintering step S15, the collection target is sintered (heated) at 850° C. or more. Thus, at least a part of the metal component included in the positive electrode active material (for example, Ni, Co, Mn, or the like) can be reduced to the state of the metal simple substance (for example, metal Ni, metal Co, metal Mn, or the like). Moreover, the reduced metal simple substance can be aggregated and the specific gravity can be increased. Thus, the metal component derived from the positive electrode active material precipitates more easily and in the separating step S30 to be described below, the separativeness of the metal component and the carbon component included in the negative electrode active material is improved. Therefore, both the higher collection rate of the carbon component and the lower loss rate of the metal component are achieved suitably. For example, in the case of sintering the collection target at 850° C. or more in the sintering step S15, the reaction as expressed by the following Formula (2) can occur. Thus, at least a part of the metal component included in the positive electrode active material can be reduced to the state of the metal simple substance.

$${LiNi}_{x} {Co}_{y} {Mn}_{z} {O}_{δ} + {C}_{1 / 2 δ} = Li + x Ni + y Co + z Mn + 1 / 2 δ \cdot {CO}_{2} \qquad ( 2 )$$

It is only necessary that the heating temperature in the sintering step S15 (more specifically, the temperature in a heating furnace) is 850° C. or more. As the heating temperature increases, it becomes more likely that the metal simple substance is generated easily and the metal simple substance is aggregated easily. As described above, when the metal simple substance is generated and moreover, aggregated, the specific gravity increases and the precipitability is improved. In order to separate the metal component and the carbon component more efficiently in the separating step S30 to be described below, it is preferable that most part of the metal component be reduced to the state of the metal simple substance and the metal simple substance be aggregated suitably. Therefore, from such a viewpoint, the heating temperature is preferably 875° C. or more, and may be 900° C. or more. On the other hand, from the viewpoint of reducing the metal component, the upper limit of the heating temperature is not limited in particular and may be 1500° C. or less, 1400° C. or less, or 1300° C. or less. In consideration of the cost reduction for the sintering step S15, for example, the upper limit of the heating temperature is preferably 1200° C. or less, more preferably 1100° C. or less, and particularly preferably 1000° C. or less.

Although there is no particular limitation, it is preferable to heat the collection target in an inert atmosphere in the sintering step S15. In this case, the supply of the oxygen element to the collection target during the heating can be prevented and at least a part of the metal oxide (such as lithium-transition metal complex oxide) can be reduced more suitably to the state of the metal simple substance. Moreover, emission of the carbon component as carbon dioxide, which is greenhouse gas, can be minimized. Specifically, in the sintering step S15, it is preferable to heat the collection target while feeding an inert gas such as argon or nitrogen. Note that the term “inert atmosphere” in this specification refers to a heating atmosphere mainly containing the aforementioned inert gas. That is to say, the inert atmosphere is not limited to a perfectly inert atmosphere in which the content of the inert gas is 100% (the content of the oxygen element is 0%) and includes a heating atmosphere in which the content of the oxygen element is 5% or less (preferably 3% or less, more preferably 1% or less, still more preferably 0.5% or less, and particularly preferably 0.1% or less).

Since the sintering time in the sintering step S15 is different depending on the amount of collection target and the like, the sintering time is not defined generally. The sintering time in the sintering step S15 is preferably 1 to 12 hours and more preferably 2 to 8 hours, for example.

### (2) Selecting Step S20

As illustrated in FIG. 3, the selecting step S20 is preferably performed after the heating step S10 in the processing method disclosed herein. In the selecting step S20, the metal foil for the positive electrode core body 32, the negative electrode core body 42, or the like included in the collection target after the heating step S10 is physically removed and selected. In the selecting step S20, for example, the positive electrode core body 32 and the negative electrode core body 42 may be selected from the sintered collection target with a sieve and removed from the collection target. Since the positive electrode core body 32 and the negative electrode core body 42 can be formed of the metal foils as described above, the specific gravity is small and the positive electrode core body 32 and the negative electrode core body 42 tend to float together with graphite in the separating step S30 to be described below. In view of this, the selecting step S20 is performed before the separating step S30 so that the content of the metal foil in the collection target is reduced; thus, graphite can be collected more suitably in the separating step S30. The selecting step S20 is not the step intended to remove the metal foil for the positive electrode core body 32, the negative electrode core body 42, or the like completely from the collection target.

### (3) Separating Step S30

In the separating step S30, the metal component and the carbon component in the collection target are separated and collected. In the separating step S30, a flotation mineral beneficiation method for a slurry obtained by adding water to the collection target after the heating step S10 or the collection target after the selecting step S20 is preferably employed. Flotation mineral beneficiation (flotation beneficiation) refers to physical selection of making a hydrophobic component adhere to bubbles and float and making a hydrophilic component precipitate. In the flotation mineral beneficiation, the hydrophobic component and the hydrophilic component can be separated efficiently. In the processing method disclosed herein, the metal component is the hydrophilic component and the carbon element is the hydrophobic component. Therefore, by performing the flotation mineral beneficiation on the slurry including the collection target, the carbon component (graphite in particular), which is the hydrophobic component, can be floated and the metal component (valuable metal), which is the hydrophilic component, can be precipitated; thus, these components can be collected in the separated state.

In the separating step S30 using the flotation mineral beneficiation, first, water is added to the collection target after the heating step S10 or the collection target after the selecting step S20 to prepare a slurry including the collection target. Next, a foaming agent and a scavenger are added to the slurry and stirred. The slurry is stirred with air introduced thereto, so that the carbon component, which is the hydrophobic component, is attached to the bubbles and floated. Thus, the carbon component is collected. On the other hand, since the remaining slurry includes the metal component derived from the positive electrode active material, the slurry is collected. Thus, the carbon component and the metal component can be separated suitably and collected.

When the metal component derived from the positive electrode active material and the carbon component derived from the negative electrode active material are separated and collected in accordance with the flotation mineral beneficiation, sintering is generally performed at a temperature of about 500° C. in order to remove the binder, the film on the surface of the positive electrode active material, and the like for the higher hydrophobicity. According to the present inventors' examination, however, the positive electrode active material has a particle diameter of about 10 μm to 20 μm and a true density of about 4.5 g/cm³ and therefore precipitates more easily than the carbon material (graphite in particular) but sometimes floats together with the carbon material. In the processing method disclosed herein, on the other hand, by heating (sintering) at 850° C. or more, the metal component included in the positive electrode active material can be reduced (metallized) to the state of the metal simple substance and the specific gravity can be increased to about 8.9 g/cm³. Furthermore, by aggregating the metallized metal component, the weight per metal particle can be increased and the precipitability can be improved more. Therefore, the flotation of the metal component together with the carbon component in the separating step S30 can be suppressed and the loss rate of the metal component (loss rate of positive electrode active material) can be reduced. Since the separativeness is improved, the condition that collects the carbon component as much as possible can be employed; thus, the collection rate of the carbon component is improved. Accordingly, by the processing method disclosed herein, both the lower loss rate of the metal component and the higher collection rate of the carbon component can be achieved suitably.

The kinds of foaming agent and scavenger used in the flotation mineral beneficiation are not limited in particular. The foaming agent has a function of generating foams when dissolved in a solvent, and stabilizing the generated foams. Examples of the foaming agent include 4-methyl-2-pentanol (MIBC), pine oil, turpentine oil, and the like. The amount of foaming agent is not limited in particular and, for example, the amount of foaming agent relative to one ton (t) of the collection target is preferably 50 to 200 g/t and more preferably 100 to 150 g/t. The scavenger has a function of being selectively adsorbed on the surface of the carbon material and making the surface more hydrophobic. Examples of the scavenger include kerosene, heavy oil, and the like. The amount of scavenger is not limited in particular and, for example, the amount of scavenger relative to one ton (t) of the collection target is preferably 50 to 200 g/t and more preferably 100 to 150 g/t.

By drying the carbon material collected in the separating step S30 as appropriate, the carbon material can be used suitably as the battery material (negative electrode material). The metal component collected in the separating step S30 is separated in the respective metals by suitably performing steps similar to the conventional ones such as an acid leaching step, a neutralizing precipitating step, and a solvent extracting step, so that the metal component can be suitably used as the battery material (positive electrode material).

The processing method for the battery member according to this embodiment has been described. In the processing method disclosed herein, as described above, by sintering the collection target at 850° C. or more, the separativeness of the metal component included in the positive electrode active material and the carbon component included in the negative electrode active material can be improved and the respective components can be collected suitably. Note that the art disclosed herein is not limited to the aforementioned embodiment and includes other embodiments with various structures changed.

### Test Examples

Test Examples regarding the art disclosed herein will be described below. The contents of Test Examples given below do not intend to limit the art disclosed herein.

### 1. Preparation of Test Sample

(Example 1) In this test, a mixture of the positive electrode plate and the negative electrode plate was the collection target and a test sample was prepared in accordance with the following procedure. First, the secondary battery corresponding to the collection target was prepared. As the positive electrode plate of the secondary battery, the positive electrode core body (Al foil) having the positive electrode active material layer disposed on the surface was prepared. Note that the positive electrode active material in the positive electrode active material layer was a lithium-nickel-cobalt-manganese complex oxide (LiNi_{1/3}Co_{1/3}Mn_{1/3}O₂). As the negative electrode plate, the negative electrode core body (Cu foil) having the negative electrode active material layer applied on the surface was prepared. The negative electrode active material in the negative electrode active material layer was graphite. Then, this secondary battery (mixture of positive electrode plate and negative electrode plate) was crushed and a powder body sample was prepared.

Next, a part of the prepared powder body sample was extracted and dissolved in sulfuric acid. Then, the solution was subjected to ICP and the total amount of substance of Ni, Co, and Mn, which is M, was measured. Based on the composition of the positive electrode active material (LiNi_{1/3}Co_{1/3}Mn_{1/3}O₂), the amount of substance that is twice the total amount of substance, M, was defined as the amount of substance of the oxygen element, N (N=2M). In this test, the thermogravimetry-differential thermal analysis (TG-DTA) was performed on a part of the powder body sample. In this thermogravimetry-differential thermal analysis, the powder body sample was heated in an air atmosphere of 800° C. Note that in this analysis, the temperature rising speed was set to 5° C./min from room temperature (20° C.) to 800° C. Thus, the amount of carbon in the prepared powder body sample was measured. Then, whether the ratio (C/O ratio) of the amount of substance of the carbon element to that of the oxygen element that were measured was more than or equal to the stoichiometric ratio of CO₂ (1/2) was examined. As a result, the powder body in Example 1 had a C/O ratio of 1/2 or more.

Next, the powder body sample was heated in the inert atmosphere. Specifically, in Example 1, the powder body sample was accommodated in an electric furnace, and while Ar gas was supplied, the temperature in the furnace was increased to 1000° C. At this time, the temperature rising speed was set to 5° C./min. While the temperature in the furnace was kept at 1000° C., the heating was conducted for five hours. After that, the temperature in the furnace was reduced to 50° C. and then, the powder body sample according to Example 1 was collected.

The collected powder body sample was made into the heated sample through a sieve with an opening size of 500 μm. After 25 g of the heated sample was supplied to a flotation beneficiation cell, conditioning (mixing) was performed for five minutes at a rotation speed of 700 rpm. Next, 3.1 mL of kerosene (100 g/t in solid content) as the scavenger was added and the slurry was subjected to the conditioning for three minutes. Next, 3.1 mL of 4-methyl-2-pentanol (MIBC) (100 g/t in solid content) as the foaming agent was added and the slurry was subjected to the conditioning for two minutes. After that, air was supplied with a blowing amount of 2 L/min and the flotation mineral beneficiation was performed. During one minute of the flotation mineral beneficiation, the generated foams were collected. The collected foams were washed with water and thus, the sample according to Example 1 was obtained.

### Example 2 to Example 6

In Example 2 to Example 6, the temperature in the furnace was changed as shown in Table 1. Except this change, the process similar to that in Example 1 was performed and samples according to Example 2 to Example 6 were obtained. In each of the powder body samples according to Example 2 to Example 6, the ratio (C/O ratio) of the amount of substance of the carbon element to that of the oxygen element that were measured was more than or equal to the stoichiometric ratio of CO₂ (1/2).

### Example 7

In Example 7, a secondary battery (mixture of positive electrode plate and negative electrode plate), which is similar to that in Example 1, was prepared as the collection target. This secondary battery was crushed and by using a sieve with an opening size of 500 μm, a powder body sample was prepared. Then, 25 g of the powder body sample was supplied to a flotation beneficiation cell and the flotation mineral beneficiation was performed under a condition similar to that of Example 1; thus, a sample according to Example 7 was obtained. That is to say, in Example 7, the flotation mineral beneficiation was performed without heating the powder body sample.

### 2. Evaluation Test

### (1) Calculation of Collection Rate of Carbon Component

A flotation sample after the flotation mineral beneficiation in each example was subjected to the TG-DTA and the collection rate of the carbon component in each example was calculated. Specifically, the flotation sample after the flotation mineral beneficiation in each example was dried, and then the amount of carbon was calculated based on the amount of decrease in weight in the TG-DTA. By dividing this amount of carbon by the amount of carbon in the sample supplied to the flotation beneficiation cell, the collection rate of the carbon component in each example was calculated. The results are shown in Table 1.

### (2) Calculation of Loss Rate of Metal Component

A precipitation sample after the flotation mineral beneficiation in each example was subjected to the ICP analysis and the loss rate of the metal component in each example was calculated. Specifically, the precipitation sample after the flotation mineral beneficiation in each example was dried, and then acid dissolving was performed, which was followed by the ICP analysis. Thus, the amount of metal derived from the positive electrode active material in the sample was calculated. By dividing this amount of metal by the amount of metal derived from the positive electrode active material in the sample supplied to the flotation beneficiation cell, the collection rate of the metal component in each example was calculated. By subtracting the collection rate of the metal component in each example from 100(%), the loss rate of the metal component in each example was calculated. The results are shown in Table 1.

TABLE 1

| | | Flotation | | |
|---|---|---|---|---|
| | Heating | mineral | Collection | Loss rate |
| | temperature | beneficiation | rate of carbon | of metal |
| | (° C.) | time (min) | component (%) | component (%) |
| Example 1 | 1000 | 1 | 95 | 4 |
| Example 2 | 900 | 1 | 94 | 4 |
| Example 3 | 850 | 1 | 91 | 4 |
| Example 4 | 800 | 1 | 85 | 7 |
| Example 5 | 650 | 1 | 65 | 5 |
| Example 6 | 300 | 1 | 43 | 2 |
| Example 7 | — | 1 | 21 | 9 |

As shown in Table 1, it is understood that the collection rate of the carbon component is 90% or more and the loss rate of the metal component is 4% or less in Example 1 to Example 3. It is presumed that this is because heating the powder body sample at 850° C. or more reduced most part of the metal component to the state of the metal simple substance and the aggregation of the reduced metal component increased the specific gravity, thereby improving the precipitability. Additionally, it is presumed that, by performing the separating step after the heating step, the separativeness of the metal component and the carbon component was improved, and even if the collection rate of the carbon component was high, the loss rate of the metal component was able to be suppressed.

The art disclosed herein has been described above in detail; however, these are just examples and will not limit the scope of claims. The art described in the scope of claims includes those in which the specific examples given above are variously modified and changed. That is to say, the art disclosed herein includes modes according to the following Items 1 to 6.

<Item 1> The processing method for the battery member, including the heating step of heating at 850° C. or more, the collection target including the positive electrode containing at least the lithium-transition metal complex oxide with the layer structure and the negative electrode containing the carbon material; and the separating step of adding the foaming agent and the scavenger to the slurry including the collection target after the heating step and separating the metal component and the carbon component included in the collection target.

<Item 2> The processing method according to Item 1, in which the positive electrode includes the metal foil as the positive electrode core body and the negative electrode includes the metal foil as the negative electrode core body, and the selecting step of selecting the metal foil included in the collection target is further provided before the separating step.

<Item 3> The processing method according to Item 1 or 2, in which the lithium-transition metal complex oxide with the layer structure contains at least Ni and Co.

<Item 4> The processing method according to any one of Items 1 to 3, in which the heating step is performed in the inert atmosphere.

<Item 5> The processing method according to any one of Items 1 to 4, in which the heating step includes the reducing component adding step of adding the reducing component so that the amount of substance of the reducing component becomes more than or equal to the threshold based on the stoichiometric ratio of the oxide of the reducing component relative to the amount of substance of the oxygen element in the collection target.

<Item 6> The processing method according to Item 5, in which the reducing component is the carbon element and the threshold is the value more than or equal to the stoichiometric ratio of CO₂.

### REFERENCE SIGNS LIST

1 Lithium ion secondary battery
10 Case
12 Positive electrode terminal
14 Negative electrode terminal
20 Electrode body
30 Positive electrode plate
32 Positive electrode core body
34 Positive electrode active material layer
40 Negative electrode plate
42 Negative electrode core body
44 Negative electrode active material layer
50 Separator

What is claimed is:

1. A processing method for a battery member, comprising:
a heating step of heating at 850° C. or more, a collection target including a positive electrode containing at least a lithium-transition metal complex oxide with a layer structure and a negative electrode containing a carbon material; and
a separating step of adding a foaming agent and a scavenger to a slurry including the collection target after the heating step and separating a metal component and a carbon component included in the collection target.

2. The processing method according to claim 1, wherein
the positive electrode includes a metal foil as a positive electrode core body and the negative electrode includes a metal foil as a negative electrode core body, and
a selecting step of selecting the metal foil included in the collection target is further provided before the separating step.

3. The processing method according to claim 1, wherein the lithium-transition metal complex oxide with the layer structure contains at least Ni and Co.

4. The processing method according to claim 1, wherein the heating step is performed in an inert atmosphere.

5. The processing method according to claim 1, wherein the heating step includes a reducing component adding step of adding a reducing component so that an amount of substance of the reducing component becomes more than or equal to a threshold based on a stoichiometric ratio of an oxide of the reducing component relative to an amount of substance of an oxygen element in the collection target.

6. The processing method according to claim 5, wherein the reducing component is a carbon element and the threshold is a value more than or equal to a stoichiometric ratio of CO₂.

7. A processing method for a battery member, comprising:
a heating step of heating at 850° C. or more, a collection target including a positive electrode containing at least a lithium-transition metal complex oxide with a layer structure and a negative electrode containing a carbon material; and
a separating step of adding a foaming agent and a scavenger to a slurry including the collection target after the heating step and separating a metal component and a carbon component included in the collection target, wherein
the positive electrode includes a metal foil as a positive electrode core body and the negative electrode includes a metal foil as a negative electrode core body, and
a selecting step of selecting the metal foil included in the collection target is further provided before the separating step;
the lithium-transition metal complex oxide with the layer structure contains at least Ni and Co;
the heating step is performed in an inert atmosphere;
the heating step includes a reducing component adding step of adding a reducing component so that an amount of substance of the reducing component becomes more than or equal to a threshold based on a stoichiometric ratio of an oxide of the reducing component relative to an amount of substance of an oxygen element in the collection target; and
the reducing component is a carbon element and the threshold is a value more than or equal to a stoichiometric ratio of CO₂.
